(19) United States
(12) Patent Application Publication
(10) Pub. No.: US 2002/0057892 A1
(43) Pub. Date: May 16, 2002

(54) VIDEO RECORDING DEVICE INCLUDING THE ABILITY TO CONCURRENTLY RECORD AND PLAYBACK

(76) Inventors: YOSHIZUMI MANO, CUPERTINO, CA (US); CHENCHU CHILAMAKURI, FREMONT, CA (US); HISATO SHIMA, SARATOGA, CA (US)

Correspondence Address: HAVERSTOCK & OWENS LLP, 162 NORTH WOLFE ROAD, SUNNYVALE, CA, 94086, US

(21) Appl. No.: 08/941,584

(22) Filed: Sep. 30, 1997

(51) Int. Cl. H04N 5/76; H04N 5/781

(52) U.S. Cl. 386/46; 386/125

(57) ABSTRACT

A video recording device includes the ability to record a video broadcast or video program while concurrently replaying a previously recorded video broadcast. This previously recorded video broadcast can be the same video broadcast that is recording or a different video broadcast. The record and playback operations are preferably triggered and controlled through a television on which the user can watch the playback of the recorded program. The viewer enters the data and commands for recording and playback preferably using a remote control device. Video programs are preferably recorded on a mass storage device. Preferably, the mass storage device is a hard disk drive coupled to the television through an IEEE 1394 serial bus network. Alternatively, any other appropriately configured memory device can be used to store the video programs. The television uses write commands to transmit to and record the program onto the mass storage device and read commands to retrieve previously recorded portions of a program to be replayed from the mass storage device. When playing back a previously recorded program or the recorded portions of a program which is still being recorded, the television will retrieve the packets of data from the mass storage device in sequence, using read commands to read from the appropriate locations where the appropriate packets have been stored. Each packet is then retrieved in sequence from the beginning of the program, even if the end portion of the program is still being recorded.

### FIELD OF THE INVENTION

The present invention relates to the field of recording and replaying video broadcasts. More particularly, the present invention relates to the field of recording a video program while concurrently replaying a previously recorded video program.

### BACKGROUND OF THE INVENTION

The IEEE 1394 standard, “P1394 Standard For A High Performance Serial Bus,” Draft 8.0v2, Jul. 7, 1995, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. An example of an ideal application for the transfer of data isochronously would be from a video recorder to a television set. The video recorder records images and sounds and saves the data in discrete chunks or packets. The video recorder then transfers each packet, representing the image and sound recorded over a limited time period, during that time period, for display by the television set. The IEEE 1394 standard bus architecture provides multiple channels for isochronous data transfer between applications. A six bit channel number is broadcast with the data to ensure reception by the appropriate application. This allows multiple applications to concurrently transmit isochronous data across the bus structure. Asynchronous transfers are traditional data transfer operations which take place as soon as possible and transfer an amount of data from a source to a destination.

The IEEE 1394 standard provides a high-speed serial bus for interconnecting digital devices thereby providing a universal I/O connection. The IEEE 1394 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394 standard is very thin in size compared to other bulkier cables used to connect such devices. Devices can be added and removed from an IEEE 1394 bus while the bus is active. If a device is so added or removed the bus will then automatically reconfigure itself for transmitting data between the then existing nodes. A node is considered a logical entity with a unique address on the bus structure. Each node provides an identification ROM, a standardized set of control registers and its own address space.

The IEEE 1394 cable environment is a network of nodes connected by point-to-point links, including a port on each node's physical connection and the cable between them. The physical topology for the cable environment of an IEEE 1394 serial bus is a non-cyclic network of multiple ports, with finite branches. The primary restriction on the cable environment is that nodes must be connected together without forming any closed loops.

The IEEE 1394 cables connect ports together on different nodes. Each port includes terminators, transceivers and simple logic. A node can have multiple ports at its physical connection. The cable and ports act as bus repeaters between the nodes to simulate a single logical bus. The cable physical connection at each node includes one or more ports, arbitration logic, a resynchronizer and an encoder. Each of the ports provide the cable media interface into which the cable connector is connected. The arbitration logic provides access to the bus for the node. The resynchronizer takes received data-strobe encoded data bits and generates data bits synchronized to a local clock for use by the applications within the node. The encoder takes either data being transmitted by the node or data received by the resynchronizer, which is addressed to another node, and encodes it in data-strobe format for transmission across the IEEE 1394 serial bus. Using these components, the cable physical connection translates the physical point-to-point topology of the cable environment into a virtual broadcast bus, which is expected by higher layers of the system. This is accomplished by taking all data received on one port of the physical connection, resynchronizing the data to a local clock and repeating the data out of all of the other ports from the physical connection.

A conventional video cassette recorder (VCR) allows a user to record video broadcasts from a television broadcast signal or other video signal input to the VCR. When recording a video broadcast on a conventional VCR a user must wait until the VCR is finished recording the broadcast before viewing the beginning of the broadcast. For example, a user who comes home during the middle of the recording of a television broadcast cannot start watching the recording of the television broadcast from the beginning until that recording is finished. In order to start watching the beginning of the recording, the user would have to stop the recording and would then lose the ability to record and watch the end of the broadcast. A conventional VCR will not allow a viewer to watch the beginning of a recorded television broadcast while concurrently recording the ending of the television broadcast. Correspondingly, a conventional VCR will not allow one program to be recorded while concurrently playing back a previously recorded program.

What is needed is an apparatus which will allow a user to time-shift a recording of a video broadcast in order to view the broadcast from the beginning while concurrently recording the remainder of the video broadcast. What is further needed is an apparatus which will also allow a user to record one video program while concurrently playing back a second video program.

### SUMMARY OF THE PRESENT INVENTION:

A video recording device includes the ability to record a video broadcast or video program while concurrently replaying a previously recorded video broadcast. This previously recorded video broadcast can be the same video broadcast that is recording or a different video broadcast. The record and playback operations are preferably triggered and controlled through a television on which the user can watch the playback of the recorded program. The viewer enters the data and commands for recording and playback preferably using a remote control device. Video programs are preferably recorded on a mass storage device. Preferably, the mass storage device is a hard disk drive coupled to the television through an IEEE 1394 serial bus network. Alternatively, any other appropriately configured memory device can be used to store the video programs. The television uses write commands to transmit to and record the program onto the mass storage device and read commands to retrieve previously recorded portions of a program to be replayed from the mass storage device. When playing back a previously recorded program or the recorded portions of a program which is still being recorded, the television will retrieve the packets of data from the mass storage device in sequence, using read commands to read from the appropriate locations where the appropriate packets have been stored. Each packet is then retrieved in sequence from the beginning of the program, even if the end portion of the program is still being recorded.

### BRIEF DESCRIPTION OF THE DRAWINGS:

FIG. 1 illustrates a block diagram of an IEEE 1394 serial bus network including a computer system, a video cassette recorder (VCR), a video camera and a television.

FIG. 2 illustrates a block diagram of the internal components of the computer system 14.

FIG. 3 illustrates a block diagram of an IEEE 1394 serial bus network including a computer system, a VCR, a video camera, a television and an external hard disk drive.

FIG. 4 illustrates a block diagram of components within a television of an alternate embodiment of the present invention.

### DETAILED DESCRIPTION OF THE PREFERRED EMBODIMENT:

A video recording device of the present invention includes the ability to record a video broadcast while concurrently replaying a previously recorded portion of a video broadcast. This video broadcast being replayed can be the same video broadcast that is recording or a different video broadcast which has been previously recorded. When recording a video broadcast or program, the recording of the program is completed in sequence, each recorded packet of data representing the video broadcast during a specific portion of time. As described above, when recording on a conventional VCR the user cannot watch the recording from the beginning, while still recording the end portion of the program. Both the recording and replaying operations take place at real time speeds.

The apparatus of the present invention will allow a user to watch a previously recorded portion of a program while still recording the remaining portion of the program. For example, for a user desiring to watch the beginning of a thirty minute program which is being recorded and is only half complete, the video recording device of the present invention will continue to record the program for the second fifteen minutes while allowing the user to watch the program from the beginning. When the user begins watching the program, the apparatus will continue to record the program in sequence, so that there will be a constant time difference between the portion of the program being viewed by the user and the portion of the program being recorded. Once the program is finished recording, the user can continue to view the program in sequence until the user has viewed the entire program. The user also has the ability to fast forward and rewind through the already recorded portion of the program while the remainder of the program is recorded. The user can also record one video broadcast while concurrently watching another previously recorded video broadcast. The concurrency of these operations is aided by the IEEE 1394 serial bus network. This bus protocol operates sufficiently fast that both the record and playback operations can occur concurrently, for example within a same video time period, and appear real time to a user. Thus, no data or signal is lost.

The record and playback operations are preferably triggered and controlled through a television on which the user can watch the playback of a recorded program. The viewer enters the data and commands for recording a television broadcast or other program preferably using a remote control device. The viewer also enters the playback command preferably using the remote control device. The video program is recorded on a mass storage device or other appropriately configured memory device. Preferably, the mass storage device is a hard disk drive coupled to the television through an IEEE 1394 serial bus network. This hard disk drive is either resident within a computer system coupled to the television or the hard disk drive is an external hard disk drive coupled to the television. Alternatively, the mass storage device is included within the television for recording the program.

The record operation is programmed by a viewer using a remote control device to enter the relevant control data such as the program starting time, ending time and the channel or source of the program. Beginning at the starting time, the television then sends the video data for the program to the mass storage device for storing. The television will use write operations to send the program to the mass storage device in packets for storing the data at a known location within the mass storage device. Each packet of data represents the program during a specific portion of time. The viewer can then replay recorded programs and recorded portions of programs using the remote control device to instruct the television to replay the specified program. When playing back a previously recorded program or the recorded portions of a program which is still being recorded, the television will retrieve the packets of data from the mass storage device in sequence, using read commands to read from the appropriate locations where the appropriate packets have been stored. Each packet is then retrieved in sequence from the beginning of the program, even if the end portion of the program is still being recorded. If the end portion of the program is still being recorded, the television will send the packets of data representing the video program to the mass storage device, while also reading the appropriate packets for playback from the mass storage device. Accordingly, the apparatus of the present invention will record a video program while also allowing a user to replay a previously recorded program or the previously recorded portions of the same video program.

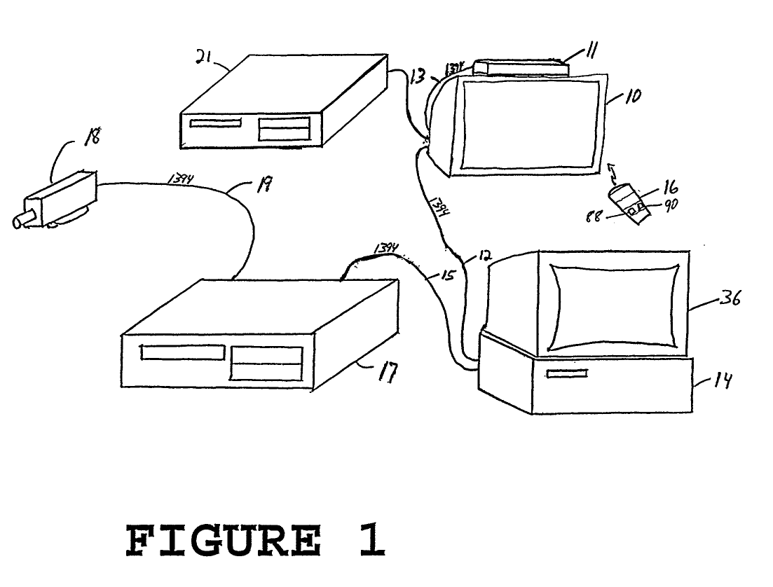

A block diagram of an IEEE 1394 serial bus network including a computer system, a VCR, a video camera and a television, is illustrated in FIG. 1. The computer system 14 includes an associated display 36 and is coupled to the television 10, by an IEEE 1394 serial bus cable 12. A settop box 11 is coupled to the television 10 by an IEEE 1394 serial bus cable 13. A VCR 17 is coupled to the computer system 14 by an IEEE 1394 serial bus cable 15. A video camera 18 is coupled to the VCR 17 by an IEEE 1394 serial bus cable 19. Together, the settop box 11, the television 10, the computer system 14, the VCR 17 and the video camera 18 form an IEEE 1394 serial bus network. A second VCR 21 is coupled to the television through a traditional VCR interface circuit and is not part of the IEEE 1394 serial bus network.

A wireless cursor control/input device 16 provides input and control signals to the television 10. The wireless cursor control/input device 16 includes a record button 88 and a playback button 90. The wireless cursor control/input device 16 also includes other input and control buttons typically associated with such devices, including but not limited to pause, fast forward and rewind buttons. The wireless cursor control/input device 16 preferably communicates with the television 10 using infrared signals. Alternatively, any other suitable cursor control/input device can be substituted for the device 16, including but not limited to a wired input device, a radio frequency input device and a wired or wireless keyboard with integral cursor control device.

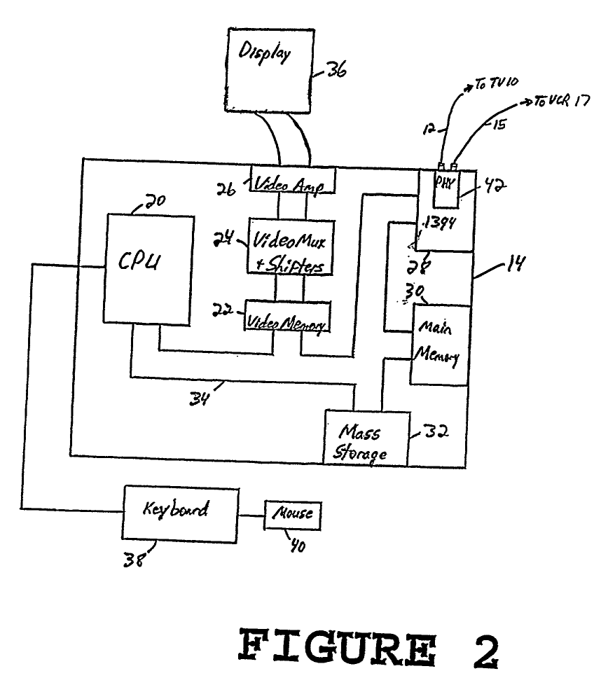

A block diagram of the internal components of the computer system 14 is illustrated in FIG. 2. The computer system 14 includes a central processor unit (CPU) 20, a main memory 30, a video memory 22, a mass storage device 32 and an IEEE 1394 interface circuit 28, all coupled together by a conventional bidirectional system bus 34. The interface circuit 28 includes the physical interface circuit 42 for sending and receiving communications on the IEEE 1394 serial bus. The physical interface circuit 42 is coupled to the television 10 and to the VCR 17, over the IEEE 1394 serial bus cables 12 and 15, respectively. In the preferred embodiment of the present invention, the interface circuit 28 is implemented on an IEEE interface card within the computer system 14. However, it should be apparent to those skilled in the art that the interface circuit 28 can be implemented within the computer system 14 in any other appropriate manner, including building the interface circuit onto the motherboard itself. The mass storage device 32 may include both fixed and removable media using any one or more of magnetic, optical or magneto-optical storage technology or any other available mass storage technology. The system bus 34 contains an address bus for addressing any portion of the memory 22 and 30. The system bus 34 also includes a data bus for transferring data between and among the CPU 20, the main memory 30, the video memory 22, the mass storage device 32 and the interface circuit 28.

The computer system 14 is also coupled to a number of peripheral input and output devices including the keyboard 38, the mouse 40 and the associated display 36. The keyboard 38 is coupled to the CPU 20 for allowing a user to input data and control commands into the computer system 14. A conventional mouse 40 is coupled to the keyboard 38 for manipulating graphic images on the display 36 as a cursor control device.

A port of the video memory 22 is coupled to a video multiplex and shifter circuit 24, which in turn is coupled to a video amplifier 26. The video amplifier 26 drives the display 36. The video multiplex and shifter circuitry 24 and the video amplifier 26 convert pixel data stored in the video memory 22 to raster signals suitable for use by the display 36.

A record operation is programmed using the remote control device 16 (FIG. 1) to enter the relevant control data such as the program starting time, ending time and the channel or source of the program. This information is stored within a memory in the television 10 (FIG. 1). At the program starting time, the television 10 (FIG. 1) will begin transmitting packets of data representing the program, to the mass storage device 32 (FIG. 2) within the computer 14 (FIG. 2). These packets of data are transmitted over the IEEE 1394 serial bus network and then stored on the mass storage device 32 (FIG. 2). Preferably, an isochronous recording channel is established over the IEEE 1394 serial bus network between the television 10 (FIG. 1) and the computer system 14 (FIG. 2) for the transmission of the packets to be stored.

A viewer can playback a stored program, using the playback button 90 (FIG. 1) on the remote control device 16 (FIG. 1) to instruct the television 10 (FIG. 1) to begin playing the program. When receiving a playback command, the television 10 (FIG. 1) will retrieve the packets of data, in sequence, from the beginning of the program from the mass storage device 32 (FIG. 2), using read commands to read the packets of data from the appropriate locations on the mass storage device 32 (FIG. 2). The packets of data are then transmitted from the mass storage device 32 (FIG. 2) to the television 10 (FIG. 1). Preferably, an isochronous channel is established over the IEEE 1394 serial bus network, between the computer system 14 (FIG. 2) and the television 10 (FIG. 1) for the transmission of the packets from the mass storage device 32 (FIG. 2) to the television 10 (FIG. 1).

Once the television receives the packets of data from the mass storage device 32 (FIG. 2), the video and audio information represented by the packet of data is displayed by the television 10 (FIG. 1). When the television 10 (FIG. 1) is recording and playing back portions of the same program or portions of two different programs, a packet of data is transmitted to and from the mass storage device 32 (FIG. 2) during each time period. In this manner, one packet of data is stored from the program being recorded and one packet of data is retrieved for the program being replayed during each time period.

Any type of video information which can be displayed on the television 10 (FIG. 1) can be stored and played back in this manner. The television 10 (FIG. 1) will display video information from a number of sources including the settop box 11 (FIG. 1), the VCR 17 (FIG. 1) and the video camera 18 (FIG. 1), over the IEEE 1394 serial bus network, and also the VCR 21 (FIG. 1). Video information from any of these sources, which is displayed on the television 10 (FIG. 1) can be stored within the mass storage memory device 32 (FIG. 2).

Once a video program or portions of a video program are stored, the viewer can then retrieve the information by depressing the playback button 90 (FIG. 1). When the playback button 90 (FIG. 1) is depressed, the television 10 (FIG. 1) will retrieve the appropriate packets from the mass storage device 32 (FIG. 2). This retrieval is accomplished by a read operation to the address within the mass storage device 32 (FIG. 2) where the information was stored. The mass storage device 32 (FIG. 2) will then retrieve that information and the computer system 14 (FIG. 2) will transmit the information to the television 10 (FIG. 1) over the IEEE 1394 serial bus network. The television 10 (FIG. 1) then displays the information for the viewer. The viewer can also use the pause, next frame, previous frame, fast forward and rewind functions when viewing and editing prerecorded packets of video information.

The viewer can also save a program or portions of a program by recording the program on a tape in another available recording device, such as the video camera 18 (FIG. 1) or the VCR 17 (FIG. 1). To record a program saved on the mass storage device 32 (FIG. 2) on a tape, the appropriate packets of information to be recorded are transmitted from the memory storage device 32 (FIG. 2) to the selected recording device over the IEEE 1394 serial bus network.

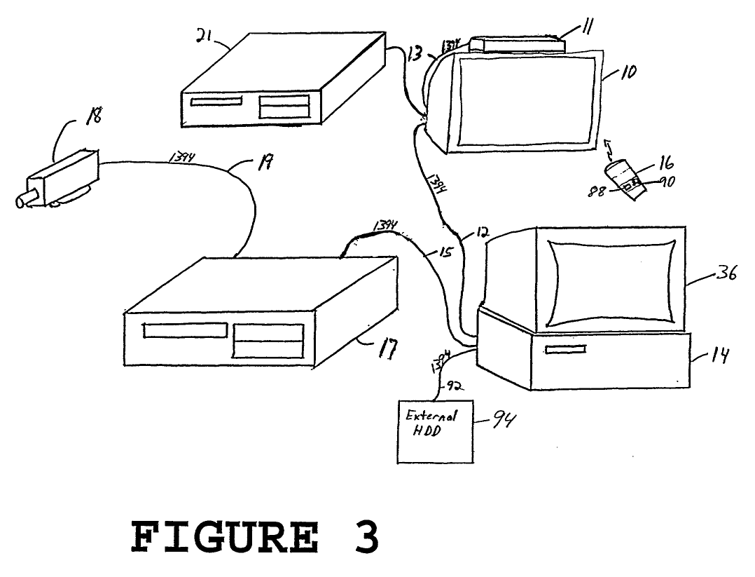

Within the preferred embodiment of the present invention, the packets of data to be recorded are transmitted from the television 10 (FIG. 1) to a mass storage device, as described above. While the mass storage device 32 (FIG. 2) within the computer system 14 (FIG. 2) can be used to store this information, it is also possible to use another mass storage device coupled to the television 10 (FIG. 1). A block diagram of an IEEE 1394 serial bus network including an external hard disk drive is illustrated in FIG. 3. This IEEE 1394 serial bus network includes the devices of FIG. 1 and the external hard disk drive 94 which is coupled to the computer system 14 by the IEEE 1394 serial bus cable 92.

In the network illustrated in FIG. 3, packets of data within a program to be recorded are transmitted from the television 10 to the external hard disk drive 94 over the IEEE 1394 serial bus network. The external hard disk drive 94 will then store that video information for later retrieval and playback, as described above.

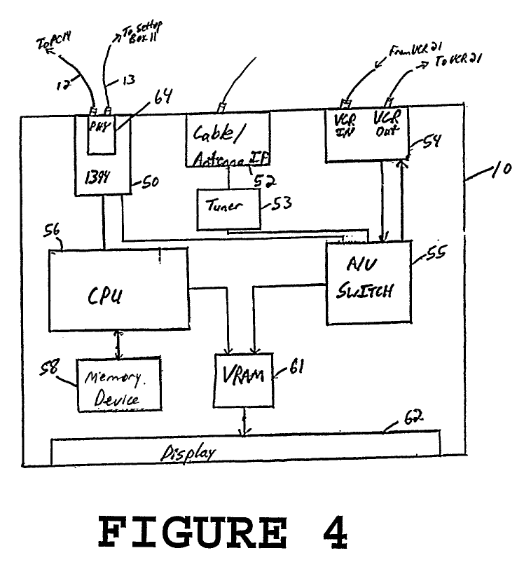

In still a further alternate embodiment, the television 10 includes a memory device which will store video information to be instantaneously recorded. A block diagram of components within this embodiment of the television 10 is illustrated in FIG. 4. An IEEE 1394 interface circuit 50 includes a physical interface circuit 64. The physical interface circuit 64 is coupled to the PC 14 and to the settop box 11, over the IEEE 1394 serial bus cables 12 and 13, respectively. The IEEE 1394 interface circuit 50 is coupled to a CPU 56 for controlling communications between the CPU 56 and devices coupled to the IEEE 1394 serial bus network. The IEEE 1394 interface circuit 50 is also coupled to an audio/video switch 55 for providing video signals from the devices coupled to the IEEE 1394 serial bus network. A cable/antenna interface circuit 52 is coupled to receive input signals from a coaxial cable or an antenna and to pass those signals through a tuner 53 to an audio/video switch 55. A traditional VCR interface circuit 54 is coupled to receive input signals from the VCR 21 and to output signals to the VCR 21. The VCR interface circuit 54 is also coupled to the audio/video switch 55 for directing audio/video signals to and from the VCR 21.

A memory device 58 is coupled to the CPU 56 for storing information. The audio/video switch 55 and the CPU 56 are coupled to the video random access memory (VRAM) circuit 61 for providing video input signals to the VRAM circuit 61 from the multiple sources. The VRAM circuit 61 provides the video signals to the display 62. If a compressed video stream of data is received by the television 10, that stream of data is decompressed before being sent to the VRAM circuit 61 by a coder/decoder circuit (CODEC) or other appropriate decompression engine, within the television 10.

Using the television 10, illustrated in FIG. 4, packets of data within a program to be recorded are transmitted to and stored within the memory device 58. When the playback button 90 is then pressed, the television 10 will read the information from the memory device 58 and display it on the display 62 for the viewer.

The video recording device of the present invention records video programs on a mass storage device for later retrieval and playback. Preferably, the mass storage device is a hard disk drive coupled to the television through an IEEE 1394 serial bus network. This hard disk drive is either resident within a computer system coupled to the television or the hard disk drive is an external hard disk drive coupled to the television. Alternatively, the mass storage device is included within the television for storing the video programs. In a further alternate embodiment, any appropriate memory device is used to store the video programs, including a flash device.

The record operation is initiated or programmed by a viewer using a remote control device. The viewer pushes a record button on the remote control device to instruct the television to initiate recording of the video program currently displayed on the television or the viewer will enter the relevant control data for recording a program, such as the program starting time, ending time and the channel or source of the program. The television then routes the packets of data within the program to be recorded to the mass storage device. After storing the information, the viewer can then subsequently replay the information, by pressing a playback button. When the viewer presses the editing playback button, the television will retrieve the stored information from the mass storage device and display it for the viewer. A previously recorded program or the recorded portions of the program being recorded can be retrieved and displayed while the same or a different program is being recorded. Once stored within the mass storage device, the viewer can also save the recorded program onto a video tape by transferring the program from the mass storage device to a VCR, video camera or other appropriate recording device coupled to the mass storage device, for recording.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is used with an IEEE 1394 serial bus structure, the present invention could also be implemented on any other appropriate bus structures.

We claim:

1. A video recording apparatus for recording and replaying video programs comprising:
a. a memory device for receiving and storing a video stream of data;
b. a transmitting circuit coupled to the memory device and to receive a video stream of data to be recorded for transmitting the video stream of data to the memory device when a record command is received;
c. a receiving circuit coupled to the memory device, to the display and to the transmitting circuit for retrieving the video stream of data from the memory device when a playback command is received, wherein the memory device is configured for concurrently recording and retrieving video data.

2. The video recording apparatus as claimed in claim 1 further comprising a display for displaying the video stream of data when the video stream of data is retrieved by the receiving circuit.

3. The video recording apparatus as claimed in claim 1 wherein the transmitting circuit is an IEEE 1394 serial bus interface circuit.

4. The video recording apparatus as claimed in claim 1 wherein the record and playback commands are received from an input device.

5. The video recording apparatus as claimed in claim 4 wherein the input device is a wireless remote control device.

6. The video recording apparatus as claimed in claim 1 wherein the memory device is a hard disk drive.

7. The video recording apparatus as claimed in claim 6 wherein the transmitting circuit is an IEEE 1394 serial bus interface circuit.

8. The video recording apparatus as claimed in claim 7 wherein an isochronous channel is used to transmit the video stream of data between the transmitting circuit and the memory device.

9. The video recording apparatus as claimed in claim 1 wherein the transmitting circuit and the receiving circuit are included within a transceiver circuit.

10. A television for recording and playing video streams of data comprising:
a. a display for displaying video information; and
b. a communications circuit coupled to receive a video stream of data and configured for coupling to a memory device for transmitting the video stream of data to the memory device for storing the video stream of data within the memory device and receiving a stored video stream of data from the memory device when a playback command is received, wherein the communications circuit is configured for concurrently of transmitting and receiving video data.

11. The television as claimed in claim 10 wherein the memory device is external to the television and the communications circuit is an IEEE 1394 serial bus interface circuit.

12. The television as claimed in claim 10 wherein the memory device is internal to the television.

13. The television as claimed in claim 10 further comprising an input device for sending the record and playback commands.

14. The television as claimed in claim 13 wherein the input device is a wireless remote control device.

15. The television as claimed in claim 10 wherein the time period is a clock cycle.

16. A method of recording and replaying video streams of data comprising the steps of:
a. receiving a stream of video data to be recorded;
b. transmitting the stream of video data to a memory storage device;
c. storing the stream of video data within the memory storage device;
d. receiving a command to playback a previously recorded stream of video data; and
e. retrieving the previously recorded stream of video data from the memory storage device;
wherein the steps of transmitting and retrieving are performed concurrently during a same time period when a stream of video data is to be recorded while a previously recorded stream of video data is retrieved.

17. The method as claimed in claim 16 wherein the video stream of data is transmitted over an IEEE 1394 serial bus network.

18. The method as claimed in claim 17 wherein the memory storage device is a hard disk drive.

19. The method as claimed in claim 18 wherein the record and playback instructions are received from a remote control device.
